(19) United States
(12) Patent Application Publication
(10) Pub. No.: US 2003/0015423 A1
(43) Pub. Date: Jan. 23, 2003

(54) Method and apparatus for calibrating a pH/ISE meter

(76) Inventors: Alfred J. LaGreca, Winchester, MA (US); David E. Butz, Groton, MA (US)

Correspondence Address: CESARI AND MCKENNA, LLP, 88 BLACK FALCON AVENUE, BOSTON, MA, 02210, US

(21) Appl. No.: 10/184,459

(22) Filed: Jun. 28, 2002

Related U.S. Application Data
(63) Continuation-in-part of application No. 09/875,752, filed on Jun. 6, 2001, now abandoned.
Application No. 09/875,752 is a continuation of application No. 09/262,416, filed on Mar. 4, 1999, now abandoned.

(51) Int. Cl. G01N 27/333

(52) U.S. Cl. 204/416

(57) ABSTRACT

Apparatus for calibrating a pH/ISE meter includes a solution chamber for receiving a standard pH/ISE electrode adjustably suspended in the chamber. Inlets are provided into the chamber so that a wash solution and buffers may be introduced into the chamber by gravity, the introduction of these liquids being controlled by valves controlled by a controller. The chamber also has a drain outlet which is opened and closed by a similar valve under the control of the controller. The controller controls the valves in a pre-determined sequence to flush and fill the chamber first with a wash solution, and then with buffers so that the electrode is immersed in each buffer long enough to enable an associated pH/ISE meter to obtain a stable reading of the pH/ISE value of the buffer. After the final buffer has been emptied from the chamber, the controller controls the valves to flush and fill the chamber with a solution. The controller may also include provisions for introducing into the chamber a specimen solution whose pH/ISE value is to be determined and measuring the value of that solution. Alternatively, the electrode in the chamber may be removed and placed in a separate sample chamber to be read by the calibrated pH/ISE meter. A calibration method is also disclosed.

### CROSS-REFERENCE TO RELATED APPLICATIONS

The present application is a continuation-in-part of Ser. No. 09/875,752, filed Jun. 06, 2001, now, which is a continuation of Ser. No. 09/262,416, filed on Mar. 04, 1999, now abandoned.

### BACKGROUND OF THE INVENTION

This invention relates to pH/ISE meters. It relates more particularly to a method and apparatus for calibrating a pH/ISE meter.

A pH/ISE meter is an instrument for measuring the pH and/or ISE value of a solution in order to determine the hydrogen-ion concentration of that solution on a pH scale from 0 to 14 and/or an ISE scale as listed in ThermoOrion Product Catalog 240176-001, cited in the Annual Book of ASTM Standards, Water and Environmental Technology, American Society for Testing and Materials 1992. A typical pH/ISE meter includes an electrode or probe in the form of small sealed tube filled with a reference fluid. A conductor extends into one end of the tube and contacts the fluid specimen, a second contact or conductor on the outside of the tube is grounded, both conductors being connected to a pH/ISE meter. In use, the probe is immersed in a specimen solution whose pH/ISE value is to be measured. Due to the characteristics of the fluid inside and outside of the probe, a voltage is produced which is applied to the pH/ISE meter which thereupon determines the pH/ISE value of the specimen solution and then displays that value.

Before measuring the pH/ISE value of a specimen solution, it is common practice to calibrate the meter and the meter's pH/ISE probe using standard buffer or calibration solutions with known pH/ISE values. Currently, the industry uses three standard pH calibration solutions with pH values of 4.00, 7.00 and 10.00 and specific ion calibration solutions, e.g. chloride, fluoride and sodium, based upon a specific ion selective electrode (ISE). Invariably all pH/ISE meters and their probes are calibrated each time they are used and the technician usually performs the calibration with one or two of the above three standard solutions, the particular solution depending on the estimated pH/ISE value of the unknown solution or sample. This is usually referred to as a one or two point calibration. There are applications where more than a two-point calibration is needed, and in some applications, a five-point calibration is routinely performed. For example, assuming the user wants to calibrate the pH/ISE meter the two-point method (using the pH 4 and 7 standards, for example) the user carries out the following steps manually:

1. clean the pH/ISE probe with a wash solution such as de-ionized water and dry the probe;

2. place one of the two standard buffer solutions, usually the one with the lower pH/ISE value, i.e., pH 4.00, in a clean vial and immerse the electrode in that solution;

3. after a stable pH/ISE reading is obtained, set the pH/ISE meter to the value of that standard solution, i.e., pH=4.00, as the reported value regardless of the actual meter reading;

4. clean and dry the electrodes as described in Step 1;

5. repeat Steps 2 and 3 using the second standard solution, i.e. pH—7.00;

6. repeat the cleaning step to have the electrode ready for measuring the pH/ISE value of the specimen solution.

The procedure for a one point calibration is similar to the above except only one standard solution, e.g., pH=4.00, is used.

It is apparent that the above manual procedure requires the use of several different clean vials or the repeated re-washing of the same vial and repeated washing of the pH/ISE electrode prior to taking each reading. This calibration process is tedious, time consuming, damages electrodes due to the calibration manipulation, is prone to human error, cannot be replicated easily, encourages less frequent calibrations and increases the likelihood of sample reading errors.

### SUMMARY OF THE INVENTION

Accordingly, it is an object of the present invention to provide a method for automatically calibrating a pH/ISE meter of the portable, handheld, benchtop variety, and its electrode before the meter is used to measure the pH/ISE value of a given solution.

Another object of the invention is to provide such a method which is universal to all pH meters and pH electrodes and all ISE meters and ISE electrodes.

Yet another object of the invention is to provide an automatic pH/ISE meter calibration method which can be performed quickly and easily by relatively unskilled personnel simply by their placing the pH/ISE electrode in a solution chamber and pushing a single button.

A further object of the invention is to provide apparatus for carrying out the above method to automatically calibrate pH/ISE meters.

Another object of the invention is to provide calibration apparatus of this type which dispenses buffers and samples by gravity using low voltage solenoid valves only so that the apparatus presents no danger in a laboratory.

A further object is to provide in calibration apparatus a safe storage location and environment for a pH/ISE electrode, so as to prolong the useful life of the electrode.

Still another object of the invention is to provide such apparatus having an electrode holder and chamber to facilitate the safe and easy placement of all standard electrodes in and out of buffers and fluid samples.

A further object of the invention is to provide apparatus of this type which allows for calibration documentation for good manufacturing practice (GMP), good laboratory practice (GLP), standard operating procedure (SOP) and which minimizes the manipulation of the pH/ISE electrode during the calibration procedure.

The invention accordingly comprises the several steps and the relation of one or more of such steps in respect to each of the others, and the apparatus embodying the features of construction, combination of elements and arrangement of parts which are adapted to effect such steps, all as exemplified in the following detailed description, and the scope of the invention will be indicated in the claims.

Briefly, in accordance with our method, a wash solution and the various standard buffers are routed in a predetermined sequence to a special solution chamber in which the electrode of the pH/ISE meter being calibrated may be placed. A combination of gravity and special dedicated fluid routing valves is used to control the flows of the various solutions to and from the solution chamber. A programmable controller interfaced with the pH/ISE meter controls the various valves to carry out the sequence of steps required to perform the automatic pH/ISE calibration procedure to be described in detail hereinafter.

The apparatus that carries out our calibration method is specifically designed for laboratory use and operates on low voltage power, i.e. 24 volts DC. One embodiment of the apparatus is separate from the pH/ISE meter and may be electrically connected thereto by a standard RS-232 connector. A second apparatus embodiment incorporates the pH/ISE meter right into the calibration apparatus and may display pH/ISE values which are temperature corrected according to the measured buffer and sample temperatures. Both apparatus embodiments can perform a standard calibration automatically with the push of a single button.

After a pH/ISE meter and its electrode have been calibrated in accordance with our method, the pH/ISE value of a specimen solution may be obtained in any one of three ways. As we shall see, the calibration apparatus may include provisions for delivering a specimen solution from a built-in sample container in a controlled manner to the solution chamber whereupon the pH/ISE value of the sample may be displayed by the pH/ISE meter. On the other hand, if the apparatus does not include a separate sample container and a dedicated flow path to the solution chamber for the sample, the sample can be manually poured into the solution chamber containing the electrode. As a third choice, after calibration the electrode can be removed manually from the solution chamber and placed in a separate vial containing the sample solution and the pH/ISE value for the sample read by the pH/ISE meter.

Our calibration method is not limited as to the number of buffers or calibration solutions that may be used during a given calibration procedure. Preferably, however, the apparatus for carrying out our method should have containers and dedicated flow paths from the containers to the solution chamber for at least three pH buffers, e.g. pH 4, pH 7 and pH 10, or three ISE buffers, e.g. chloride, fluoride, and sodium, as well as for a cleaning or wash solution such as de-ionized water.

As we shall see, our calibration apparatus is relatively easy to manufacture and simple to operate. Therefore it should find wide acceptance in laboratories required to perform pH/ISE measurements of large numbers of specimen solutions.

### BRIEF DESCRIPTION OF THE DRAWINGS

For a fuller understanding of the nature and objects of the invention, reference should be made to the following detailed description taken in connection the accompanying drawings, in which:

FIG. 1 is a left front perspective view from above of apparatus for automatically calibrating a pH/ISE meter;

FIG. 2 is a similar view of a second apparatus embodiment;

FIG. 3 is a right rear perspective view from below on a smaller scale of the FIGS. 1 and 2 apparatus embodiments;

FIG. 4 is a left rear perspective view from below showing the FIGS. 1 and 2 apparatus with the bottom cover removed;

FIG. 5 is a diagrammatic view of a calibration apparatus embodiment including provisions for automatically measuring a sample solution following the calibration procedure, and

FIG. 6 is a timing diagram illustrating the operation of the FIG. 5 apparatus.

### DESCRIPTION OF THE PREFERRED EMBODIMENTS

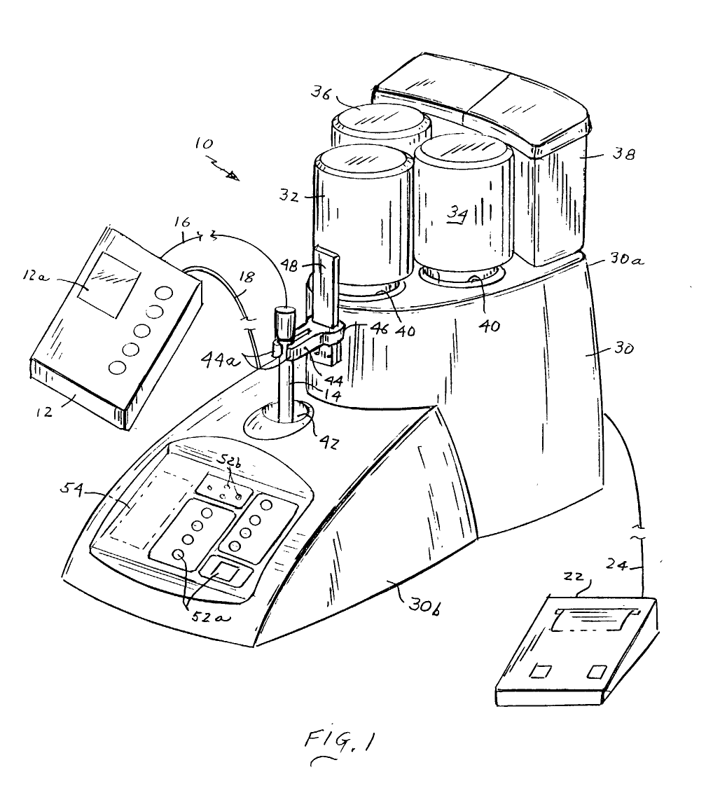

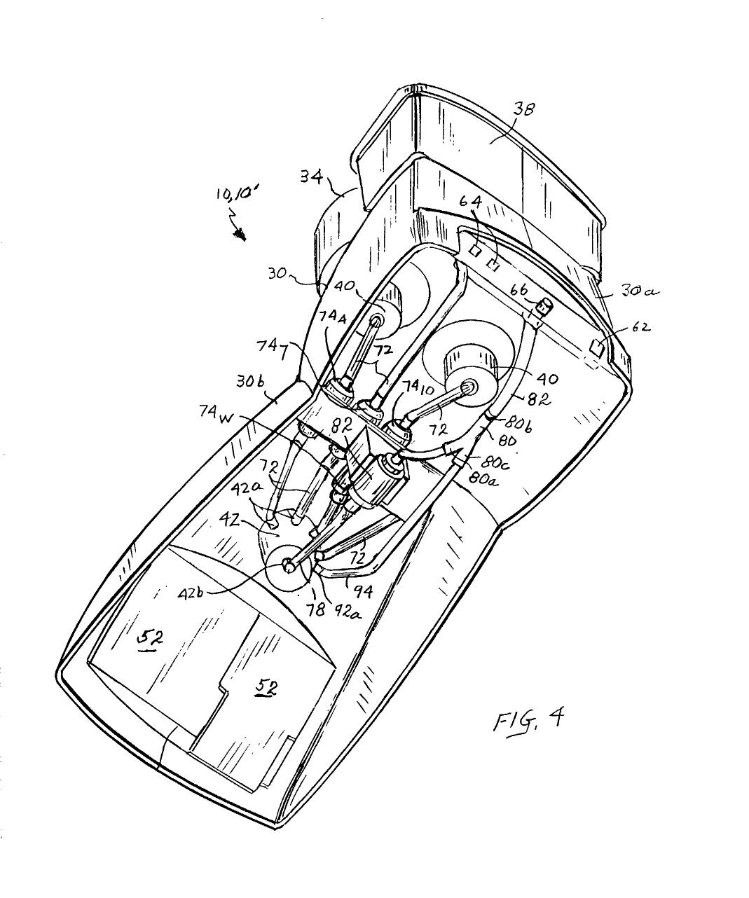

FIGS. 1 and 3 show generally at 10 an embodiment of our calibration apparatus adapted to calibrate a separate conventional pH/ISE meter 12 and the meter's electrode 14 connected to the meter by a wire 16. Preferably, meter 10 may also be connected electrically to meter 12 by a cable 18 terminated by a standard RS-232 connector. The measured pH/ ISE readings may be displayed by the meter's display panel 12a and the results of the calibration may be printed out by a conventional printer 22 connected by a similar cable 24 to apparatus 10.

The pH/ISE electrode 14, which is a standard item of manufacture, is basically a closed, thin-wall glass tube or vial about 12 mm in diameter filled with a reference liquid having a selected pH/ISE value. The electrode includes a sensing bulb at the working end of the electrode, a wire with a built-in reference electrode, reference junctions and usually also one or more temperature sensors. When the working end of the electrode is immersed in a liquid, an electrical potential is developed across the electrode contacts which reflects the difference in the pH/ISE values of the liquids inside and outside the electrode 14. That voltage is applied to the meter 12 which thereupon displays on its display panel 12a the pH/ISE value of the liquid in which the electrode 14 is immersed. The operation of pH/ISE meters is well known and therefore will not be described in more detail here; but see the above-referenced ThermoOrion catalog.

As shown in FIGS. 1 and 3, apparatus 10 includes a housing 30 having a rear section 30a that supports a plurality of vented containers. The illustrated apparatus 10 has four such containers, i.e. a container 32 for containing a wash or cleaning solution such as de-ionized water, a container 34 for containing pH 4 buffer solution, a container 36 for pH 10 buffer and a larger container 38 for containing the most commonly used buffer, pH 7. Preferably, these containers seat in receptacles 40 formed in the top wall of housing section 30a.

Housing 30 also includes a forwardly projecting section 30b having formed in its top wall an open solution chamber 42 adapted to receive the working end of the electrode 14 of pH/ISE meter 12. In order to conveniently move the electrode 14 in and out of solution chamber 42, apparatus 10 includes a clip-like holder 44 having a pair of resilient arms 44a adapted to engage electrode 14 from opposite sides. The base of the holder 44 is formed as a slider 46 which is adapted to slide up and down along a vertical slide 48 mounted to the front of housing section 30a behind chamber 42 so that the electrode is in line with the chamber 42.

Housing section 30b also contains a control panel 52 having various control buttons 52a for directing a controller 54 in section 30b to perform a programmed calibration procedure using the pH or ISE buffers in containers 34, 36, and 38. For example, there may be a pH4, pH7, pH10, pH4/7, pH7/10, pH 4/7/10 buttons which may be de-pressed to cause the apparatus to perform the indicated one, two or three-point calibration. There may also be a WATER button to initiate a procedure that rinses electrode 14 to fill the chamber with wash solution, i.e. clean water. There may also be a DRAIN button to drain chamber 42 and a CANCEL/STOP button to stop a calibration sequence. Panel 52 may also include various LED status indicators 52b including POWER-ON, READY-TO-CALIBRATE and ERROR.

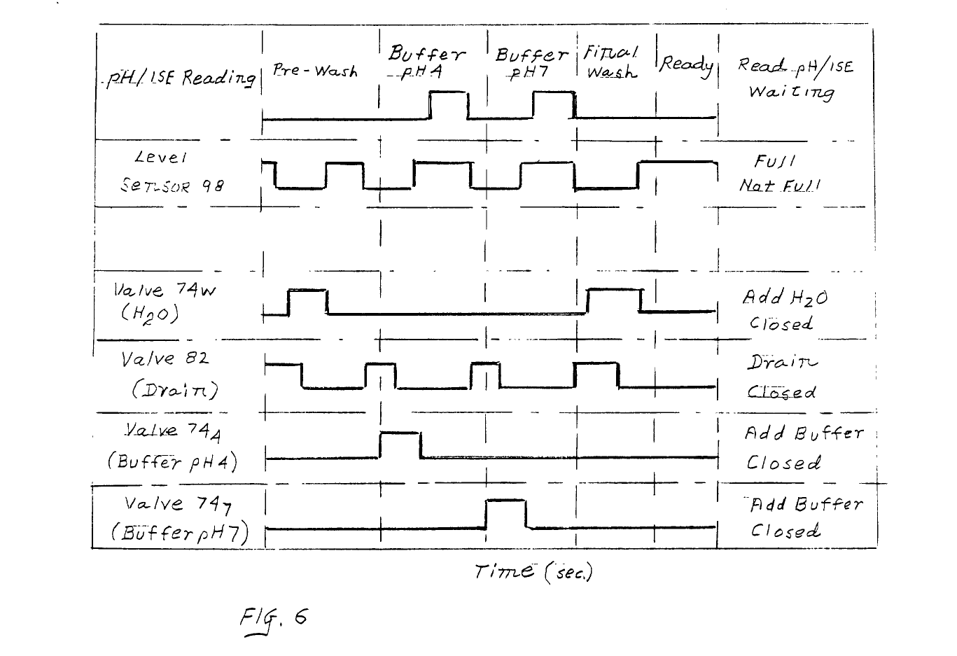

As shown in FIG. 3, the rear wall of housing section 30a may support various control elements including an on/off power switch 62 and RS 232 connectors 64 for electrically connecting the meter cable 16 and printer cable 24 to apparatus 10. There is also a drain outlet 66 by way of which liquids are drained from the solution chamber 42 to a waste container or sink S as shown in FIG. 5. The bottom of housing 30 is normally closed by a bottom panel 68 to protect the housing contents.

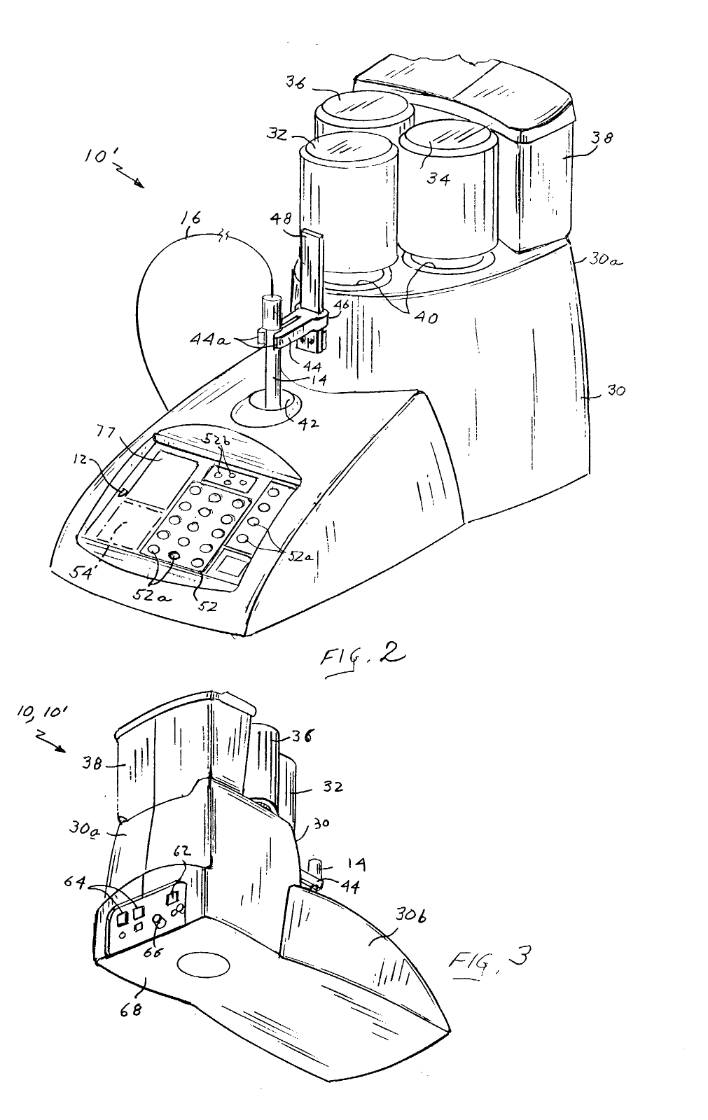

FIG. 2 of the drawings shows generally at 10′ an enhanced embodiment of our calibration apparatus in which the pH/ISE meter 12 is incorporated right into the housing section 30b. Accordingly, apparatus 10′ includes a display panel 77 which displays both the measured pH/ISE values and the results of the calibration procedure.

Apparatus 10′ also differs from apparatus 10 in that its controller 54 will interrogate the temperature sensor(s) in electrode 14 during calibration and automatically account for buffer temperatures during calibration and factor that information into the reported pH/ISE values.

Following a calibration sequence using either apparatus 10 or 10′, the electrode 14 may be removed from holder 44 and inserted into a vial containing a sample solution whose pH or ISE value is to be measured. Alternatively, the electrode 14 may be positioned in solution chamber 42 and the sample poured manually into that chamber for the measurement. Most preferably, the apparatus may include another separate container for the sample, and dedicated means for automatically routing the sample to chamber 42 following the calibration procedure as will be described later in connection with FIG.5. In any event, the controllers 54 in apparatus 10 and 10′ are programmed as to carry out the functions to be described as commanded by instructions entered into control panel 52 by the operator.

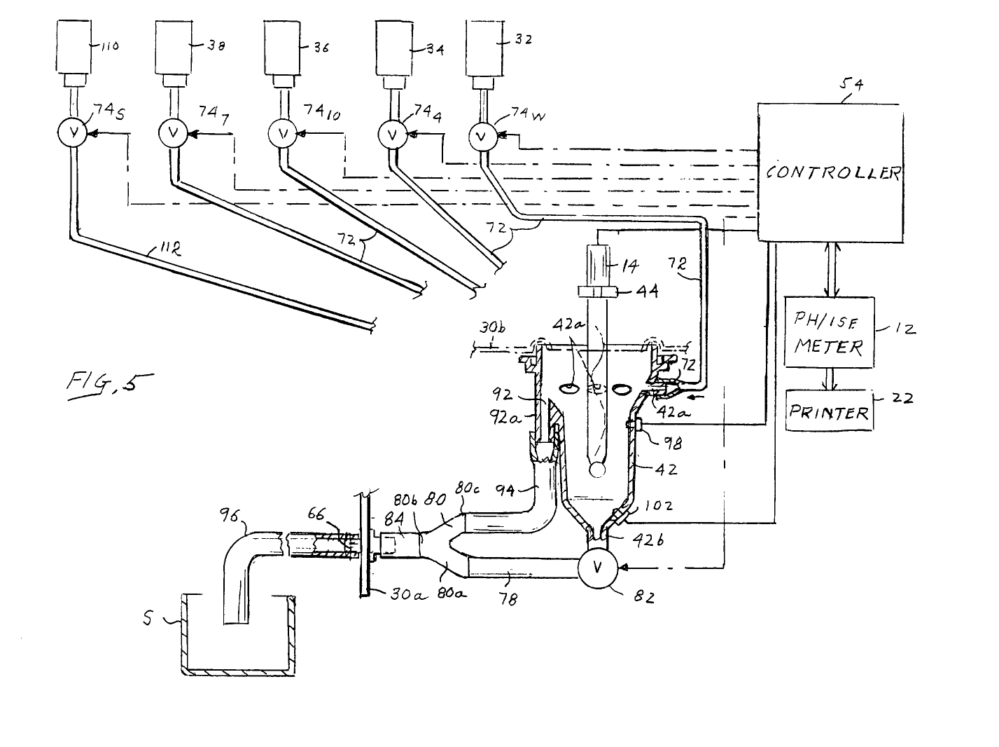

As seen in FIGS. 4 and 5, the solution chamber 42 of apparatus 10 or 10′ is generally cylindrical having a flared side wall formed with a plurality of inlets 42a in the flare. The bottom of the electrode is closed except for a drain outlet 42b.

Each container receptacle 40 is connected to a different dedicated inlet 42a of solution chamber 42 by a dedicated fluid conduit or tube 72, the fluid flow through each conduit being controlled by an in-line, solenoid valve 74. In other words, each conduit includes a first tube section extending from the particular receptacle 40 to its valve and a second section extending from that valve to a different inlet 42a of solution chamber 42. Thus in the illustrated apparatus, there is a dedicated valve 74_{w} controlling the flow of wash solution under gravity from container 32 to chamber 42, and separate dedicated valves 74₄, 74₁₀ and 74₇ controlling the gravity flow of buffer solutions from containers 34, 36, and 38, respectively, to chamber 42.

The drain outlet 42b of solution chamber 42 is connected by a fluid conduit 78 to one arm 80a of a Y-fitting 80, the fluid flow through that conduit 78 being controlled by an in-line solenoid valve 82. The leg 80b of fitting 80 is connected by a conduit 84 to the drain outlet 66 at the back of housing 30.

As shown in FIGS. 4 and 5, an overflow outlet 92 is provided in the side wall of solution chamber 42 at the flare thereof. Opening 92 communicates with an exterior depending tubular stem 92a which is connected by a conduit 94 to the other arm 80c of the Y-fitting 80. As best seen in FIG. 5, the lower edge of the overflow opening 92 is lies just below the inlets 42a enabling the solution chamber 42 to be filled with liquid up to the lower edge of opening 92, any excess liquid being conducted out of the chamber via stem 92a and conduit 94.

When the apparatus 10 or 10′ is in use, the drain connector 66 at the back of housing 30 is connected by a suitable length of hose 96 to a waste container or sink S located below connector 66. Thus, when the drain valve 82 is opened, any liquid in the solution chamber 42 will drain out under gravity through outlet 42b to waste container or sink S. Likewise, any excess liquid in the chamber will pass out of the chamber through the overflow opening 92 directly to the waste container S.

Preferably, as shown in FIG. 5, a sensor 98 is provided in the side wall of chamber 42 below the level of the overflow opening 92 therein and which senses when chamber 42 is filled with liquid, the sensor providing a FULL signal to controller 54 when that event occurs. A second sensor 102 may be provided in the wall of chamber 42 just above the drain outlet 42b thereof to signal the controller by an EMPTY signal that the chamber 42 is substantially empty of liquid.

All of the solenoid valves 74 and 82 described above may be low voltage, 2-way valves, preferably of the type disclosed in our U.S. Pat. No. 6,050,543. They are operated under the control of controller 54 to cause the proper sequence of separate liquid flows from the various containers 32, 34, 36 and 38 solely under gravity to the solution chamber 42 and the drainage, under gravity, of those liquids from that chamber at the appropriate times in the calibration sequence.

In order to use the present apparatus 10, the electrode 14 of pH/ISE meter 12 is inserted into the solution chamber 42. This may be done by engaging the electrode to holder 44 and sliding the holder along slide 48 so that the electrode is lowered into the chamber. Alternatively, the electrode may be attached to an independent holder and placed in the chamber.

To start the calibration procedure, the operator places electrode 14 in chamber 42 and presses a START button 52a on control panel 52 which causes the controller 54 to initiate a wash cycle. The cycle can vary depending upon the desired needs, cycle time and sequence as programmed into the controller. In any event, controller 54 controls as follows:

A. Wash

| | |
|---|---|
| Step 1 - Pre-clean and Fill | controller 54 opens the valve 74_{w} |
| | from the wash solution container 32 |
| | and closes the drain valve 82 so that |
| | wash solution flows solely under |
| | gravity into the solution chamber 42 |
| | bathing electrode 14 and then drains |
| | therefrom to the vented waste con- |
| | tainer S; after, e.g. 10 seconds, the |
| | controller closes the drain valve 82 |
| | whereby chamber 42 fills with wash |
| | solution; controller 54 closes that |
| | valve 74_{w} when sensor 98 detects that |
| | chamber 42 is filled; any overflow in |
| | chamber 42 may flow out through the |
| | overflow opening 92 to the vented |
| | waste container S. |
| Step 2 - Soak | drain valve 82 remains closed for a |
| | selected time, e.g. 10 seconds, allow- |
| | ing the electrode 14 to soak in the |
| | wash solution; |
| Step 3 - Empty | drain valve 82 is opened so that the |
| | wash solution in chamber 42 drains |
| | under gravity to the vented waste |
| | container 42; after a selected time, |
| | e.g. 15 seconds, or when the sensor |
| | 102 detects that chamber 42 is empty, |
| | the controller 54 closes the drain |
| | valve 82. |
| Repeat Steps 1 through 3 (optional) | |
| Step 4 - Wash and Fill | Controller 54 opens the valve 74_{w} |
| | controlling the flow of first buffer |
| | solution from container 34 to solution |
| | chamber 42 and opens drain valve 82 |
| | so that the first buffer solution flows |
| | under gravity into chamber 42 there- |
| | by bathing the working end of elec- |
| | trode 14 in that solution and imme- |
| | diately drains from the chamber into |
| | the vented waste container S; after |
| | bathing the electrode in the first |
| | buffer solution for a selected time, |
| | e.g., 10 seconds, controller 54 closes |
| | the drain valve 82 so that chamber 42 |
| | fills with first buffer solution until |
| | sensor 98 signals the controller that |
| | the chamber is full; |
| Step 5 - Soak | electrode 14 remains immersed in |
| | chamber 42 for a selected time suffi- |
| | cient to allow pH/ISE meter 12 to |
| | obtain a stable reading of the pH/ISE |
| | value of the first calibration solution |
| | in chamber 42; |
| Step 6 - Calibration Measurement | controller 54 controls meter 12 to |
| | take a pH/ISE reading of the first |
| | buffer solution and sets the meter to a |
| | first pH/ISE calibration point 4 and |
| | that measurement is recorded in the |
| | meter's memory; |
| Step 7 - Empty | drain valve 82 is opened so that the |
| | first calibration solution drains from |
| | chamber 42 to the vented waste con- |
| | tainer S. |

B. Calibration of First Buffer Solution, e.g. pH/ISE 4

Washing Between Measurements (optional)—Repeat Steps 1 to 3

C. Calibration of Second Buffer Solution, e.g. pH/ISE 7

Same as Steps 4 to 7 except that the controller controls the valve 747 controlling the flow of pH/ISE 7 solution from container 38 so that that buffer solution flows to and from solution chamber 42.

D. Calibration Completion of Buffer Solutions

The pH/ISE meter 12 will read an acceptable slope or give an appropriate reading indicating a proper calibration between the pH/ISE meter 12 and its electrode 14.

E. Final Washing

Repeat Steps 1 to 3-pH/ISE electrode 14 and meter 12 are now ready for use.

After E. FINAL WASHING, the controller 54 controls printer 22 so that the printer prints out final calibration data such as the date and time, each buffer's measured pH/ISE value, the calculated slope and coefficient, as well as the intercept. The printer also prints out a final result, i.e. calibration successful or not. If the calibration was successful, the apparatus 10 and pH/I SE meter 12 shown in FIG. 1, or the apparatus 10′ with the integrated pH meter 12 shown in FIG. 2, is used to carry out a pH/ISE measurement on an unknown liquid specimen. This may be accomplished in one of three ways. In accordance with one method, the pH/ISE electrode may be placed in a separate vial containing the unknown sample and the pH /ISE meter 12 operated to display the pH/ISE value of that sample. Alternatively, the sample may poured manually into the solution chamber 42 of apparatus 10 or 10′ and the electrode 14 placed in that chamber as described above with a measurement carried out using the separate pH/ISE meter 12 or the integrated meter in apparatus 10′. As a third possibility, the calibration apparatus can include provisions in that apparatus for automatically flowing the sample solution to and from the solution chamber 42, after calibration, in the same manner as described above for the buffers.

An arrangement such as this is illustrated in FIG. 5 wherein a sample solution container 110 is connected by a dedicated conduit 112 to a separate, dedicated inlet 42a of solution chamber 42. Conduit 112 includes a dedicated in-line sample valve 74ₛ which is controlled by controller 54 in the same manner as the valves 74 described above. After a successful calibration as described above, controller 54 carries out the above Steps 4 to 7 for the valve 74ₛ, and the drain valve 82 so that the specimen or sample solution is first flowed through the solution chamber 42 to wash the working end of the electrode 14 and then accumulated in that chamber so that a pH/ISE measurement may be taken for the sample solution, following which the sample solution is drained from the chamber and the chamber is filled with wash solution in accordance with STEPS 1 to 3 above.

If the apparatus 10 or 10′ is not used for a selected time, e.g. 30 minutes, following completion of a calibration cycle or following the measurement of a sample, the controller 54 is programmed to drain the wash solution from chamber 42 by opening the drain valve 82 and then filling the chamber with a storage solution, which is typically the pH/ISE 7 buffer solution from container 38, in order to protect the electrode 14.

FIG. 6 shows the sequence of events that occur during a two-point pH/ISE 4/7 calibration as described above. In this diagram, the optional, repeated washing steps between measurement steps are not performed.

Of course, if a one-point calibration were being carried out on the specimen in the solution chamber 42, only a single calibration or buffer solution, e.g. pH/ISE 4, would be gravity fed to chamber 42 during calibration procedure. Also, if the estimated pH/ISE value of the specimen solution were estimated to be higher then, e.g. pH/ISE 7, then a two-point calibration using the pH/ISE 7 and pH/ISE 10 buffers would be used, with controller 54 being programmed to operate the appropriate valves 74 and 82 to gravity feed the buffers from their respective containers at the appropriate times in the calibration cycle.

Various valving arrangements may be used to conduct solutions to and drain them from the solution chamber 42. The arrangement shown in FIG. 5 is particularly suitable for the two-way solenoid valves described in the above-mentioned patent.

It will thus be seen that the objects set forth above, among those being apparent from the preceding description, are efficiently attained. It should also be understood that certain changes may be made in carrying out the above method and in the constructions set forth without departing from the scope of the invention. Therefore, it is intended that all matter contained in the above description or shown in the accompanying drawings shall be interpreted as illustrative and not in a limiting sense.

It is also to be understood that the following claims are intended to cover all of the generic and specific features of the invention described herein.

What is claimed is:

1. Apparatus for calibrating a pH/ISE meter of the type including a pH electrode or an ISE electrode having a working end and which produces an output signal indicative of a measured pH or ISE value and an indicator responsive to the output signal for indicating said measured value, said apparatus including
a solution chamber having a side wall, a bottom wall and an open top for receiving said electrode, a plurality of inlets in said side wall below said top and a drain outlet in the bottom wall;
support means for supporting the electrode so that the working end of the electrode is placed in said chamber;
a wash solution container located above said chamber;
a controllable wash valve connected between the wash solution container and a dedicated first inlet of said chamber for controlling the flow of wash solution under gravity into the chamber;
a first buffer container for a first buffer solution having a first pH/ISE value, said first buffer container being located above the chamber;
a controllable first buffer valve connected between the first buffer container and a dedicated second inlet of the chamber for controlling the flow under gravity of the first buffer solution into the chamber;
a controllable drain valve connected to the drain outlet for controlling the flow of liquid under gravity out of the chamber, and
control means programmed to control the valves so that sequentially
the chamber is first flushed and then filled with wash solution conducted thereto from said wash solution container via the wash valve so that the wash solution first washes and then soaks the electrode in the chamber,
after a selected time, the wash solution is drained under gravity from said chamber via said drain valve,
the chamber is first flushed and then filled with first buffer solution conducted thereto under gravity from the first buffer container via the first buffer valve so that the first buffer solution first washes and then soaks the electrode in the solution chamber, and
while the chamber is filled with the first buffer solution, the control means issue a first control signal for the pH/ISE meter being calibrated to measure the output voltage from the electrode while exposed to the first buffer solution to produce a first measured signal and to set said indicator to indicate said first pH/ISE value in response thereto,
following the production of said first measured signal, the first buffer solution is drained from said chamber via the drain valve,
the chamber is first flushed and then filled with wash solution conducted thereto from the wash container via the wash valve, and
after a selected time, the wash solution is drained form said chamber via the drain valve.

2. The apparatus defined in claim 1
further including a second buffer container containing a second buffer solution having a second pH/ISE value, said second buffer container being located above said chamber, a controllable second buffer valve connected between the second buffer container and a dedicated third inlet of the chamber for controlling the flow under gravity of the second buffer solution into the said chamber, and
wherein the control means are programmed to control the valves so that sequentially
the chamber is first flushed and then filled with second buffer solution conducted thereto from the second buffer container via the second buffer valve so that the second buffer solution first washes and then soaks the electrode in the chamber,
while the chamber is filled with the second buffer solution, the control means issues a second control signal for the pH/ISE meter being calibrated to measure the output voltage from the electrode to produce a second measured signal and to set said indicator to indicate said second pH/ISE value in response thereto,
following production of the second measured signal, the second buffer solution is drained from said chamber via the drain valve,
the chamber is first flushed and then filled with wash solution conducted thereto from the wash container via the wash valve, and
after a selected time, the wash solution is drained from the chamber via the drain valve.

3. The apparatus defined in claim 1 or 2
further including means for introducing a sample solution have an unknown pH/ISE value into a sample chamber following the last mentioned draining step, and
wherein the control means issue a third control signal for the pH/ISE meter to measure the output voltage from said electrode while exposed to the sample solution in the sample chamber and produce a measured sample signal that causes said indicator to indicate the pH/ISE valve of the sample solution.

4. The apparatus defined in claim 3 wherein the sample chamber is separate from said solution chamber.

5. The apparatus defined in claim 3 wherein the sample chamber comprises the solution chamber.

6. The apparatus defined in claim 1 or 2 wherein the control means control the valves so that after the last-mentioned draining step, the chamber is filled with a said buffer solution to protect the electrode in the chamber.

7. The apparatus defined in claim 1 or 2
further including a sample container for containing a sample solution having an unknown pH/ISE value, said sample container being located above the solution chamber, a controllable sample valve connected between the sample container and a dedicated third inlet of said chamber for controlling the flow of sample solution under gravity into the said chamber, and
wherein the control means control the valves so that after the last-mentioned draining step,
the chamber is first flushed and then filled with sample solution conducted thereto from the sample container via the sample valve so that the sample solution first washes and then soaks the electrode in the chamber, and
while the chamber is filled with the sample solution, the control means issue a control signal for the already calibrated pH/ISE meter to measure the output voltage from said electrode and produce a measured sample signal that causes the indicator to indicate the pH/ISE value of the sample solution.

8. The apparatus defined in claim 1 or 2
further including a sensor mounted to said chamber for detecting when said chamber is filled with liquid and sending a FULL signal to said control means in response thereto, and
wherein said control means is programmed to open said drain valve a selected time after receiving said FULL signal so as to empty said chamber.

9. The apparatus defined in claim 1 or 2
and further including a first sensor mounted to said chamber for detecting when the chamber is filled with solution and sending a FULL signal to said controller in response thereto and a second sensor mounted to said chamber for detecting when the chamber is substantially empty of solution and sending an EMPTY signal to the control means in response thereto, and
wherein the control means are programmed to stop the flow of solution to said chamber upon receiving a FULL signal and to close the drain valve upon receiving an EMPTY signal.

10. The apparatus defined in claim 1 or 2 wherein said containers are vented.

11. The apparatus defined in claim 1 or 2 wherein the support means include
a housing that also supports the chamber, and
a holder projecting from the housing over the chamber and for releasably engaging the electrode.

12. The apparatus defined in claim 11 and further including means for vertically adjusting the holder relative to the top of the chamber.

13. The apparatus defined in claim 11 including a pH/ISE meter in said housing, said meter having a pH/ISE electrode supported by the holder.

14. The apparatus defined in claim 1 or 2 and further including
an overflow outlet in said side wall of the chamber below said plurality of inlets, and
means for conducting solution from the overflow outlet and the drain outlet to a waste container located away from the chamber.

15. A method of calibrating a pH/ISE meter of the type including a pH electrode or an ISE electrode having a working end and which produces an output signal indicative of a measured pH or ISE value and an indicator responsive to the output signal for indicating said measured value, said method including the steps of
forming a solution chamber having a side wall, a bottom wall and an open top for receiving said electrode, a plurality of inlets in said side wall below said top and a drain outlet in the bottom wall;
for supporting the electrode so that the working end of the electrode is placed in said chamber;
providing a wash solution container above said chamber;
connecting a controllable wash valve between the wash solution container and a dedicated first inlet of said chamber for controlling the flow of wash solution under gravity into the chamber;
providing above the chamber a first buffer container for a first buffer solution having a first pH/ISE value;
connecting a controllable first buffer valve between the first buffer container and a dedicated second inlet of the chamber for controlling the flow under gravity of the first buffer solution into the chamber;
connecting a controllable drain valve to the drain outlet for controlling the flow of liquid under gravity out of the chamber, and
controlling the valves so that sequentially
the chamber is first flushed and then filled with wash solution conducted thereto from said wash solution container via the wash valve so that the wash solution first washes and then soaks the electrode in the chamber,
after a selected time, the wash solution is drained under gravity from said chamber via said drain valve,
the chamber is first flushed and then filled with first buffer solution conducted thereto under gravity from the first buffer container via the first buffer valve so that the first buffer solution first washes and then soaks the electrode in the solution chamber, and
while the chamber is filled with the first buffer solution, the control means issue a first control signal for the pH/ISE meter being calibrated to measure the output voltage from the electrode while exposed to the first buffer solution to produce a first measured signal and to set said indicator to indicate said first pH/ISE value in response thereto,
following the production of said first measured signal, the first buffer solution is drained from said chamber via the drain valve,
the chamber is first flushed and then filled with wash solution conducted thereto from the wash container via the wash valve, and
after a selected time, the wash solution is drained form said chamber via the drain valve.

16. The method defined in claim 15
including the additional steps of providing above the chamber a second buffer container containing a second buffer solution having a second pH/ISE value;
connecting a controllable second buffer valve between the second buffer container and a dedicated third inlet of the chamber for controlling the flow under gravity of the second buffer solution into the said chamber, and
controlling the valves so that sequentially
the chamber is first flushed and then filled with second buffer solution conducted thereto from the second buffer container via the second buffer valve so that the second buffer solution first washes and then soaks the electrode in the chamber,
while the chamber is filled with the second buffer solution, the control means issues a second control signal for the pH/ISE meter being calibrated to measure the output voltage from the electrode to produce a second measured signal and to set said indicator to indicate said second pH/ISE value in response thereto,
following production of the second measured signal, the second buffer solution is drained from said chamber via the drain valve,
the chamber is first flushed and then filled with wash solution conducted thereto from the wash container via the wash valve, and
after a selected time, the wash solution is drained from the chamber via the drain valve.

17. The apparatus defined in claim 15 or 16 including the additional steps of
introducing a sample solution have an unknown pH/ISE value into a sample chamber following the last mentioned draining step, and
controlling the pH/ISE meter to measure the output voltage from said electrode while exposed to the sample solution in the sample chamber and produce a measured sample signal that causes said indicator to indicate the pH/ISE valve of the sample solution.
